(19) United States
(12) Patent Application Publication
(10) Pub. No.: US 2006/0181150 A1
(43) Pub. Date: Aug. 17, 2006

(54) Outside lug driving track

(75) Inventor: Jules Dandurand, Sherbrooke (CA)

Correspondence Address: MERCHANT & GOULD PC, P.O. BOX 2903, MINNEAPOLIS, MN, 55402-0903, US

(73) Assignee: CAMOPLAST INC., Sherbrooke (CA)

(21) Appl. No.: 11/336,243

(22) Filed: Jan. 20, 2006

(30) Foreign Application Priority Data
Feb. 15, 2005 (CA) 2,497,011

(51) Int. Cl. B62D 55/24

(52) U.S. Cl. 305/170

(57) ABSTRACT

A track for a tracked-vehicle in which the driving power is transferred from the motor to the track through the driving sprocket via the profiles of the ground-contacting surface of the track, wherein the ground engaging surface is reinforced, at least in portions thereof where the sprocket passes, by reinforcing a base of the profiles in these portions.

### CROSS REFERENCE TO RELATED APPLICATIONS

This application claims priority on Canadian application no. 2,497,011, filed on Feb. 15, 2005.

### FIELD OF THE INVENTION

The present invention relates to an endless track for recreational vehicles such as snowmobiles or all-terrain vehicles for example. More specifically, the present invention is concerned with an endless track driven by outside lugs.

### BACKGROUND OF THE INVENTION

Typically, a track used on recreational vehicles designed to travel on snow, such as a snowmobile, or grounds, such as an all-terrain vehicle, consists of an endless body of molded rubber material that is flexible so that it may follow curvatures as it passes around drive and idler sprocket wheels forming part of the track driving system.

The inner surface of the track is usually flat with serially spaced lugs, which are adapted to engage the driving wheels. The ground-engaging surface of the track displays a series of longitudinally spaced transverse profiles for engaging the snow or ground over which the vehicle travels. These profiles thus provide traction to the vehicle on snow, mud, ice or any similar surfaces.

Usually the driving power is transferred from the motor to the track through the driving sprocket via the lugs of the inner surface of the track. New track driving systems developed have the driving power transferred from the motor to the track through the driving sprocket via the profiles of the ground-contacting surface, for an increased contact surface of the track with the ground surface at a given length thereof. However, it is found that such driving system, when using regular tracks, suffer from a premature wear out of the profile, hence an inefficient transfer of power.

Therefore, there is a need for a track mitigating the aforementioned drawbacks.

### SUMMARY OF THE INVENTION

More specifically, there is provided an endless belt track for a vehicle, the endless belt track having an inner surface and a ground-engaging surface provided with profiles engaging a driving sprocket of a power transmission system of the vehicle, wherein the ground-engaging surface comprises reinforced portions at least at locations of the ground-engaging surface where the driving sprocket passes.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 shows a segment of a track according to an embodiment of the present invention; and

FIG. 2 is a cross section of a segment of a track according to an embodiment of the present invention.

### DESCRIPTION OF EMBODIMENTS OF THE INVENTION

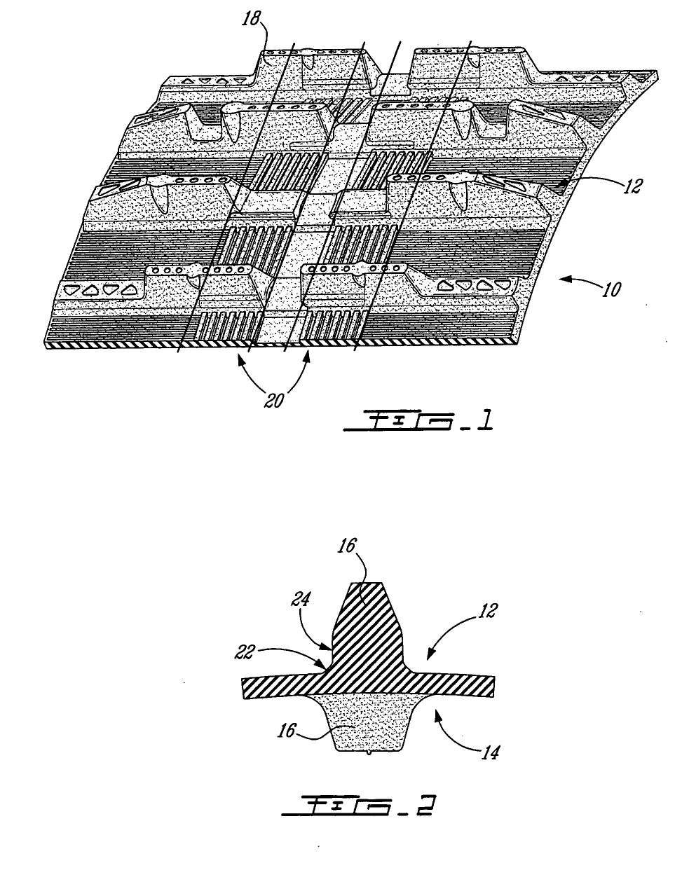

Referring to FIG. 1, there is shown a segment 10 of an endless track used for driving a recreational vehicle such as a snowmobile or an all-terrain vehicle for example.

The track 10 consists of an endless belt and having a ground engaging surface 12 and an inner surface 14.

The inner track surface 14 is provided with spaced drive lugs 16 which are spaced along a length of the inner surface 14.

The ground-engaging surface 12 comprises a series of transversally extending profiles such as 18, for engaging the drive sprocket (not shown). The profiles 28 extend generally from a center of the ground-engaging surface 12 to lateral edges thereof. The profiles 18 may be made of a rubber material.

The endless belt may be made of flexible rubber or flexible rubber reinforced by rods (not seen) to strengthen the track, as is well known in the art. Typically, conventional tracks include, embedded in the rubber material of the body of the belt and in the region of the profiles 18, such reinforcing rods, either metallic or plastic, to provide transverse rigidity to the track, as known in the art.

The track ground engaging surface 12 is reinforced in portions 20 thereof where the drive sprocket passes, by reinforcing a base of the profiles 18 in these portions, as seen in FIG. 2.

The base of the profile 18 is reinforced by an additional longitudinal layer of rubber material 22.

Such additional layer 22 obviously thickens the track on these portions 20 of engagement with the sprocket, which contributes to increase track duration.

Moreover, it is found that providing a contact between the additional layer 22 and the base of the profile 18 with a straight angle 24 increases reinforcement and maximizes power transfer efficiency by facilitating engagement of the outer lugs 18 with the sprocket.

Such longitudinal layer is further found to increase rigidity in flexion of the track. Obviously, the layer could be as wide as a width of the track. However it is found that reducing the layer to longitudinal portions of the ground-contacting surface withstanding engagement with the sprocket allows increased rigidity and protection against premature wear, while limiting an increase in weight of the track.

Interestingly, the additional layer is molded together with the belt, therefore without extra molding step.

Although the present invention has been described hereinabove by way of embodiments thereof, it may be modified, without departing from the nature and teachings of the subject invention as defined in the appended claims.

What is claimed is:

1. An endless belt track, for a vehicle having an inner surface and a ground-engaging surface provided with profiles engaging a driving sprocket of a power transmission system of the vehicle, wherein the ground-engaging surface comprises reinforced portions at least at locations of the ground-engaging surface where the driving sprocket passes.

2. The endless belt track of claim 1, wherein a base of the profiles of the ground-engaging surface is reinforced by an additional layer of rubber material.

3. The endless belt track of claim 1, wherein the endless belt track has an increased thickness in a thickness in locations of the ground-engaging surface where the driving sprocket passes.

4. The endless belt track of claim 2, wherein a contact between the additional layer and the base of the profiles is at a straight angle.

5. The endless belt track of claim 2, wherein the additional layer is as wide as a width of the endless belt track.

6. The endless belt track of claim 2, wherein the additional layer is limited in width to the base of the profiles of the ground-engaging surface.

7. The endless belt track of claim 2, wherein said additional layer is molded together with the endless belt track.

8. The endless belt track of claim 2, wherein said additional layer is in a rubber material.

9. The endless belt track of claim 1, wherein said endless belt track is be made in one of: i) a flexible rubber and ii) a reinforced flexible rubber.

10. The endless belt track of claim 1, wherein said vehicle is a recreational vehicle.

11. The endless belt track of claim 1, wherein said vehicle is one of: i) a snowmobile and ii) an all-terrain vehicle.

12. A tracked vehicle with an outside driving system, comprising an endless belt track according to claim 1.

13. An outside driving system for a tracked vehicle, comprising an endless belt track according to claim 1.
